(19) United States
(12) Patent Application Publication
(10) Pub. No.: US 2003/0076005 A1
(43) Pub. Date: Apr. 24, 2003

(54) Methods and apparatus to enhance electric currents

(76) Inventors: John W. Moreland, (US); Rodney R. Sego, Provo, UT (US)

Correspondence Address: Rodney Sego, P.O. Box 2074, Provo, UT, 84603, US

(21) Appl. No.: 09/901,193

(22) Filed: Jul. 10, 2001

(51) Int. Cl. G21H 1/00

(52) U.S. Cl. 310/301

(57) ABSTRACT

A method to safely, efficiently, compactly, and economically convert quantum energies of photons and particles of unstable, excited, and disassociating radioactive elements directly into usable amounts of electric power without going through costly, bulky, and expensive heat extraction, or through multiple transducing steps, by exciting radioactively-transformed circuit components with periodic and non-periodic electromagnetic waves of various frequencies and bandwidths, and collecting the resulting enhanced and amplified currents and voltages for human use.

### CROSS REFERENCE TO RELATED APPLICATIONS

Not Applicable

### STATEMENT REGARDING FEDERALLY SPONSORED RESEARCH OR

DEVELOPMENT:

Not Applicable

### REFERENCE TO A MICROFISHE APPENDIX

Not Applicable

### BACKGROUND OF THE INVENTION

1. Field of the Invention

This current enhancer, i.e. amplifier or electric generator structured at 10 in drawings, incorporating circuitry necessary to practice methods of invention, as it is hereinafter described, relates to the efficient production of large amounts of usable electrical energy directly from spontaneously disintegrating, unstable, radioactive elements, while minimizing losses as heat.

2. Prior Art

Historically, physicists have struggled first to understand, then to utilize the energies contained in atomic nuclei. Building on published works of Isaac Newton, the physicist, Max Planck, and later Albert Einstein, described atomic particle quantum energies. James Clerk Maxwell described electromagnetic radiation. Some others of the 19^{th} and 20^{th} century scientists who contributed to a general knowledge of atomic physics and published their theories and findings were such researchers as Ernest Rutherford, Gustav LeBon, Marie Curie, Henri Bequerel, Louis de Broglie, Clinton Davisson, Lester Germer, Arthur Compton, Enrico Fermi and Wolfgang Pauli. Added to these are the published writings of more current proponents of string and superstring relativistic quantum mechanics. These and a multitude of others, large and small, have recognized the enormous horsepower energy contained in radium, thorium, uranium, and other radioisotopes.

Many have grappled with the problems of utilizing atomic energy, with limited success, typified by the following developments. State-of-the-art devices which convert alpha and beta particles from spontaneously dissociating atoms directly into electrical energy are nuclear batteries, usually of two types, (1) a high voltage type in which a beta-emitting radioisotope is separated from a collecting electrode by a vacuum or a solid dielectric, providing thousands of volts, but a current measured in only picoamperes; and (2) a low-voltage type which yields about 1 volt with current measured in microamperes, also very little power. (Radiation Research Corporation reportedly makes a tiny high voltage battery which delivers about 500 V at 160 pA.)

Even though it produces little power, this high voltage type of nuclear battery is considered a constant-current generator. The voltage therein is proportional to the load resistance, but the current is determined by the number of nuclear emissions per second captured by the collector, and does not depend on ambient conditions nor on the load. As the radioisotope ages, the already small current gradually declines.

The low-voltage nuclear battery generally incorporates one of three different concepts: (1) a thermopile or thermocouple, (2) the use of ionized gas between two dissimilar metals, and (3) the two-step conversion of beta energy into light by a phosphor, and the conversion of the light into electric energy by means of a photovoltaic cell.

A more powerful, but still weak atomic battery is a SNAP-generator (Systems For Nuclear Auxiliary Power). One of these utilizing plutonium 238 aboard a 1961 satellite in space produced 3 watts of power for many years. One of several Apollo launches in the 1980s carried a SNAP-generator which produced much more, 50 watts, from 14 kg of Pu-238. A launch in 1997 carried 33 kg of Pu-238. In these, plutonium produced with negligible gamma radiation localized heat from alpha particles, and the localized heat across thermocouple junctions to the cold exterior of the satellite produced power in deep space for sending data back to earth. (Similar, non-nuclear, high-voltage, low-power outputs can be obtained from alternating wafers of silver and zinc, or other combinations of dissimilar metals assembled as dry pile batteries, known for about a hundred and fifty years.)

None of these batteries can deliver sufficient power for general use, but have special applications, such as in clocks, heart pacemakers and in deep space satellite probes.

Starting about during the Dwight D. Eisenhower administration, the U.S. Government undertook to build nuclear powered airplanes having aboard nuclear reactors with fuel rods to heat air to drive turbines. But such power sources were deemed too heavy and impractical for the amount of power they produced.

Large, land-based nuclear power plants create, along with useful electric power, much-disliked fission fragments, radioisotopes, and elemental transmutations, otherwise known as “nuclear waste,” more or less composed of plutonium 238 and 239, strontium 90, and barium 140, otherwise unusable, unless they are separated from each other, and re-concentrated through an expensive and hazardous process. For decades, what to do with this “nuclear waste” has been a major subject of national and international debate, because it is viewed as a toxic pollutant which is very expensive to dispose of In addition, nuclear power plants face significant, superstitious public opposition in many areas of the country and the world.

An example of a powerful but very inefficient release of atomic energy with a limited application is a thermonuclear bomb explosion which converts only about one gram of matter into unrestrained heat energy that destroys square miles (square kilometers) of surface structures and living things, as well as creating a polluting ash cloud containing several highly radioactive isotopes.

It is calculated that one pound (453.6 grams) of uranium contains energy equivalent to three million pounds (1,360,791 kg) of coal. The enormous binding energy contained in unstable atomic nuclei is well-known, but compact and efficient transducers to recover it for practical, everyday use are not known.

One problem with transducers of any type, whether it be coal fired power plants, gas-powered cars, diesel-powered electric generators, steam electric generators, piezoelectrics, fuel cells, nuclear and chemical batteries, and so on, are efficiency losses sustained as energy changes from one form to another. Transducers in the form of conventional, nuclear reactor power plants lose or waste tremendous amounts of energy in converting nuclear fission first to heat, then to steam, then to rotary motion, then to electrical energy. These transducing steps necessitate bulky and costly heat production and absorption facilities and methods. There has long been a need for a process that will convert nuclear energy directly into electric power efficiently, safely, economically, simply, and in large amounts, employing only a few parts, none of which rotate or reciprocate, in fine, a solid-state or near solid-state power source.

### SUMMARY OF THE INVENTION

Brief Descriptions of the Invention

The present invention provides methods and apparatus to convert subatomic quantum energies directly into usable electric energy, whereby humans can power their machines, homes, vehicles, aircraft, communications, farms, and businesses, more particularly using a multitude of natural and man-made radioactive or otherwise excited, atomically unstable elements and isotopes applied to transducers structured as electrical circuit components, and stimulated by oscillating voltages to recover useful amounts of electric power.

Object of the Invention

The methods and apparatus explained herein are applications of a scientific discovery overlooked by others, wherein long-known kinetic energy contained in or carried by dissociating, fast moving atomic particles and rays is efficiently recovered as electrical power to perform useful work. Amplifying electric trigger currents based on these methods and apparatus promotes utilization of plentiful supplies of radioactive elements, including so-called “nuclear waste” as energy sources to satisfy the electrical energy needs of anyone utilizing electrical power, whether for homes, businesses, communication, or for transportation. These objectives can be reached inexpensively and uncomplicatedly using this amplifier or electric generator.

Increasing energy costs and scarcity of supplies, particularly the rising costs of gasoline and diesel fuel for automobiles, trucks, and farm tractors, as well as the rising costs of natural gas and other fossil fuels, much of which is used to generate electricity, make this invention particularly important to industrial nations which use more energy in all forms than do others. But these methods and apparatus are useful to all humans, all nations, kindreds, and people.

Features of the Invention

This amplifier or generator is particularly significant in that it utilizes as little as a few grams of nuclear material, and converts the quantum energies contained in its spontaneously dissociating, sub-atomic particles into great amounts of usable electric power cleanly and safely, without massive and expensive physical plants. This generator is very unlike weak satellite batteries and other conventional means of nuclear energy transduction. The production of large amounts of electric power from a small, efficient, light-weight, solid-state power supply, without rotating or reciprocating parts, has not been done before. The methods and apparatus explained herein are non-polluting, and leave no objectionable residues behind, but only inert, stable, metallic lead isotopes or similar byproducts. In fact, the generator can easily utilize “dangerous nuclear waste” to produce useful energy. This is in sharp contrast to the abilities of bulky, expensive, technically problematic, and much-debated conventional nuclear power plants and other conventional methods of generating electric power.

Portability

This generator is portable, and with certain design refinements can be made mobile, a t far cry from the large, stationary buildings, intricate pipes and specialized fittings, cooling facilities, land requirements, and day-to-day operating problems associated with conventional plants which produce comparable amounts of electric power from radioactive or otherwise atomically unstable elements. Many of these same, costly, technical problems also afflict electric power producing plants and facilities utilizing fossil fuels, as well as plants using other methods of generating electric power, such as Sun, wind, geothermal, and water. This generator has applications in homes, automobiles, watercraft, aircraft, satellites, and in space travel, because it utilizes a compact, light-weight, and inexpensive fuel supply.

Disturbing Equilibrium

The generator is comprised of seemingly common electronic parts, or combinations of the same, with substantial alterations. The atoms in the amplifying valves or diodes, conductors, capacitors, inductors, and transformer components tend to be neutral or in a “zero” energy state, that is, each atom has balanced or equal electric charges of positive and negative electricity. Thermal energy and its equivalents, moving electric and magnetic fields, differences in voltage potential, and radioactive excitations can free bound electrons in these components, disturb the equilibrium or lower the work function, and cause electrons to flow and to do work in the electric circuit which is designed to rectify, oscillate, and amplify.

For example, by applying tiny, AM radio frequency microvoltages, or voltages of other frequencies from other sources, to an electric circuit containing electron valves (diodes, transistors and other controllable semi-conductors, as well as vacuum tubes), conductors, capacitors, and transformer cores and windings, which are doped, alloyed, surface coated, influenced, or otherwise transformed with small amounts of radioactive elements (such as UO or a multitude of other radioisotopes), the amplitude of the incoming trigger signal is greatly increased. Large amounts of usable electric power can be derived from radioactively transformed parts, beginning with the initial receiver (connected to the external antenna and ground), and ending at the load end of the circuit.

The words “radioactively transformed” used herein mean brought into contact with, surface coated, doped, alloyed, altered, influenced, changed, or modified in some manner utilizing radioactive or unstable elements, either directly or at a distance.

In other words, from a smaller, high-frequency, or even low-frequency, trigger input signal in the form of a non-periodic, modulated, audio-frequency, radio carrier wave, broadcast by a much higher frequency, periodic wave, acting upon subatomic energy emitters (i.e. alpha and beta particles and the like), a much larger, non-linear amount of output power results. The amplitude modulated radio wave is particularly receptive to pulse noise energy absorption, such as that from atmospheric disturbances, and such as that from radioactive particle frequencies and their heterodyne beat frequencies, which is one reason why FM radio became popular as a means to avoid interfering “static.”

The same amplification of trigger input power can be obtained from local oscillators which imitate the periodic and non-periodic outputs from radio stations, without the use of large external antennas and grounding components. From small electronic devices producing voice and music by whatever means are available, positive results can be obtained. Further, the trigger inputs can be supplied by laser oscillators and amplifiers, or from other stimulating energy sources utilizing periodic and non-periodic frequencies.

Power Sources

Besides alpha particles, many other naturally disassociating atomic particles, such as beta particles and gamma ray photons, even neutrons, are important to electric power production with this generator, while conventional nuclear power plants concentrate on producing and controlling only slow neutrons as a complicated method of atom-splitting to release heat.

Alpha and beta particles have electric charges, positive and negative respectively, carry quanta of energy with them, and travel at high speeds. Gamma rays (energetic x-ray equivalents) and neutrons have no charge per se, but create electrons and positive ions in substances they strike. Each one of these dissociating particles and rays (photons) radiates its electromagnetic field at a certain frequency, measurable or isotropic, whether or not that frequency is exactly the same as other similar particles. These varying frequencies and energy states are utilized by this generator.

Each alpha particle, carrying millions of electron volts of energy, causes about 86,000 ions in gas before being absorbed. Experiments within electron and proton particle accelerators have shown that atomic particle energy emissions striking targets responded to certain bands of applied resonant power, and when streams of particles under the influence of R-F electromagnetic fields were moved to and fro, the particle radiation was increased a thousandfold. This coincides with Planck's observation of emissions when pulses of energy were applied in a jerky manner to nuclear particles.

The carefully measured “half-lives” of unstable, radioactive elements directly reflect how quickly the nuclei spontaneously emit their energies. When an unstable nucleus of radium, thorium, or uranium, for instance, possesses excess energy, it ejects an alpha particle identical to a helium nucleus, made up of two protons and two neutrons, at approximately 1/10 the speed of light, carrying between 4 and 10 million electron volts of energy at a wavelength proportional to its linear momentum (de Broglie, Davisson, and Germer's λ=h/p). The alpha particle energy is dissipated or absorbed in about 4 inches (10.5 cm) of air. Alpha particles, beta particles (electrons), positrons, neutrons, protons, and other particles behave both as energetic particles and waves. Tens of thousands to millions of these may be ejected per second per gram of nuclear matter. These emitted quantum energies can be absorbed utilizing the methods and apparatus explained herein.

At the moment an alpha, beta, or other particle is spontaneously ejected from an unstable nucleus, a different nuclear element is naturally transmutated, a process which continues with each particle ejection, until the host material finally becomes a stable isotope of lead or similar element. Conventional atomic energy plants, in the process of extracting heat from unstable elements in their reactor cores, synthetically transmutate nuclear elements, daughters, or progeny, but such reactors extract the nuclear energy incompletely and inefficiently, which results in odious “nuclear waste”

It is known that the moving electric fields which radioactively ejected particles and rays carry are also accompanied by magnetic fields and vice versa. And while it is known these charged particles and rays (energetic photons) also have different frequencies and combinations of frequencies which accompany the various energy states of the charged particles, practical methods for absorbing and utilizing these different frequencies and energies to amplify man-made electromagnetic waves to which they, their harmonics, or their beat frequencies are tuned have not heretofore been developed. It is known all these particles or rays are so energetic they will ionize gases, but it is less known they influence gases, liquids, and solids in the ways utilized by this amplifier or generator. (Compton described the laws of conservation of energy and momentum relative to subatomic energy transfers.)

It is also a well-known principle of physics that when two electromagnetic waves of the same frequency superimpose in space, the resultant electric and magnetic field is the sum of the fields of the respective waves, forming a sum of vectors. It has been found in the present methods and apparatus that the same principles can be applied to solids. The sum of vectors may be composed of either natural or man-made waves, or both. When two equally strong waves have their fields in the same direction in space and time, or are in phase, the resultant field is twice that of each individual wave. The resultant intensity, being proportional to the square of the field strength, is therefore not two but four times the intensity of each of the two superimposing waves. But two opposite waves, out of phase, of the same frequency and strength, have no resultant wave at all, or are of zero intensity. Proportionally strong waves have proportional values when additive or when subtractive.

These additive and subtractive principles of wave amplification are incorporated into this generator, as they apply to trigger currents and frequencies; natural radioisotope frequencies; tuning components; tuning procedures; and absorbing and utilizing momentum and kinetic energies carried by fast-moving atomic particles and rays.

The well-known conservation of momentum (mv) and the conservation of kinetic energy (½ m times v squared) come into play when one mass strikes another at a given velocity. In the case of fast particles and rays of radioisotopes discussed herein, their energies are ultimately manifested in electric power absorbed from capturable free electrons and heat.

Rutherford found that a mixture of uranium, thorium, and radium ionizes more gas than any one of them used alone. That observation is herein interpreted to mean that the three elements named above and other unstable elements like them, when combined together, form a larger electromagnetic spectrum to bring about a more complete ionization of a given volume of gas, corresponding to different frequencies and energy states of atoms in the gas, as well as in the radioactive elements themselves. The amount of energy all these disassociating particles release is grossly underappreciated, and is possibly incorrectly measured by a large factor.

As an example of spontaneous atomic energy decay and dissipation, radium undergoes disintegration through several stages, finally forming an isotope of lead, as discovered by Pierre and Marie Curie. Radium A, a substance formed from radon gas by atomic disintegration, by further disintegration gives rise to radium B, an isotope of lead, which in turn gives rise to radium C, an isotope of bismuth, followed successively by forms C′, D, E, F (polonium), and G, an isotope of lead. Each disintegrating step releases an energy quantum or more, and these quanta ultimately possess (or induce in elements such as bismuth) electric and magnetic field phenomena absorbable by this generator.

This natural, slow release of nuclear energy, this spontaneous dissociation of atomic particles, this decay and transmutation of unstable elements goes on continuously, twenty-four hours a day every day, whether or not anyone benefits from it. These dissociations and energy releases are typical of unstable, heavy elements, and are directly utilized in this amplifier or electric generator.

Natural and Artificial Energetic Particles and Rays

Up to 1932, the first laboratory “particle accelerators” were simply naturally occurring alpha emitting elements, such as radium, which produced heavy, positively charged particles carrying energies up to 8 MeV each, an astounding amount, but far less energetic than today's particle accelerators can produce. Forming natural alpha particles with equal energies into well-defined beams for laboratory experiments was difficult to do. With the invention of the Cockcroft-Walton particle accelerator in 1932, uniform, laboratory-produced energies of 710 KeV for protons were artificially attained for the first time to react with single lithium nuclei to produce two energetic alpha particles from each atom, bringing about artificial transmutation.

In other words, the energy states of naturally ejected radioactive particles vary so much they are unfit for some scientific experiments. This amplifier or generator incorporates the principle that efficient utilization of varying quantum energies and frequencies of radioactive, atomic dissociations is attained when the frequency spectrums given off by unstable atomic photons and charged particles are matched, or even induced, by artificially generated, non-periodic and periodic electromagnetic waves. These manmade waves are enhanced by the atomic particle quantum energies, amplifying them in the neighborhood of 10 to the 15^{th} power. At the same time, the decay of radioactive elements into stable, base metal isotopes is greatly hastened as their nuclear energy reservoirs are used up.

It has long been known that one fast-moving alpha particle, 7,300 times heavier than an electron (beta particle) carries enough kinetic energy to create many free electrons and ions when it strikes a gaseous substance. This generator or amplifier applies these heavy particles or their effects in its components and circuits to greatly decrease the work function of solid conductors (and inductors), diodes and other semi-conductors, capacitors, and transformers, breaking down their surface and internal conducting resistance. This decrease in work function observed by Tesla, Einstein, and others makes the electronic components able with minimum heat losses to yield up free electrons for interaction with influential trigger currents and voltages, and with electric and magnetic fields. The fact that cathodes coated with thorium and like materials have the ability to lower thermal energy requirements to cause free electron emissions to the anodes is already known in long established vacuum tube technology, but such knowledge has not hitherto been applied to a generator such as this one.

Additional Physics Helpful to Understand This Amplifier or Generator

AM radio stations or other signal sources can produce trigger input power for this generator. From radio stations we get periodic and non-periodic waves, oscillating high frequencies, and low voltage currents which can stimulate the generator circuit. The external antenna with its Earth ground plane is also energized by the potential difference between the atmosphere above and the Earth beneath, which adds quantum energies through antenna interactions with ionized atmospheric air atoms whose charges are conducted to Earth, as well as interacting with the Earth's magnetic field, and absorbing the Earth's naturally occurring resonant frequencies. (These last are called Schumann resonances, 8, 14, 20 Hz, something identified, but perhaps incorrectly measured by Nikola Tesla, all the result of a guided wave formed when the conductive Earth beneath and the conductive ionosphere above are separated by the more or less non-conductive atmosphere in between.)

The special diodes and special capacitors added power to the circuit, in addition to that from the radioactive transformer cores. The transformer coils or inductances themselves can also be alloyed with or otherwise influenced with radioactive elements to achieve positive results, as can the antenna and counterpoise wires and every other conductor and component in the circuit.

The input signal is strengthened by conserving energy quanta from electrons and ions freed by collisions when atomic particles strike nearby conducting metal surfaces, such as in the capacitors, inductors, and amplifying valves, which energies are given up to in-phase, superimposed waves of similar non-periodic and periodic frequencies; when the input signal waves interact with naturally charged atoms in the air above; when the quantum energies in the transformer cores convert to magnetic flux; and when the fast-moving, radioactive particles strike crystal lattices in semi-conductors and conductors to free electrons and ions in the components making up the circuits of the generator.

About 50 to 200 microvolts delivering about 1 micromicrowatt at between about 520 to 1,710 kHz is the typical power received from an AM radio station, more or less, depending on the receiving antenna and other factors. Once the signal is rectified with diodes, and run through a low-pass filter, the modulated, non-periodic, audio-frequency signal is left over. This audio signal must be amplified somewhere in the neighborhood of 10 to the 12^{th} power to a minimum of about 1 watt to operate a speaker satisfactorily. If such a trigger signal were to provide useful power in the neighborhood of 4,700 watts, which this amplifier or generator provides, it would have to be amplified or enhanced to about 10 to the 15^{th} power. Of course, the trigger signal may be almost of any power level, higher or lower, and still work well. The trigger signal does not need to be low power.

The audio frequency range includes both the non-periodic, human speaking and hearing range. The total human speaking voice range is 85 Hz to 1,100 Hz, 65 to 1,200 Hz for singing, but with overtones or harmonics it will go as high as 8,000 Hz. The human hearing range, especially that of young children on the other hand, is 15 Hz to 20,000 Hz, a range of over 10 octaves. A young man's voice in normal conversation ranges from about 100 Hz to 400 Hz in its basic, fundamental range. A telephone wire transmits frequencies in the range of 300 to 3,500 Hz.

Further, in sound frequencies, such as that produced by a violin, the whole string will vibrate to produce the fundamental note. It may also vibrate in two halves, one half moving up while the other moves down, the midpoint, or node, remaining stationary. The string may vibrate in thirds with two nodes, or in fourths with three nodes, and so on. Each of these more complicated vibrations produces an overtone, or a note of a higher pitch than the fundamental because shorter portions of the string produce it. A violin string will vibrate in all these ways simultaneously, depending on how the string is bowed. And the violin wood itself will resonate to some vibrations more than others, the nature of resonance depending on the exact shape of the violin, the type of wood, the varnish, and so on. The oscilloscope records the note full of overtones as a relatively complex curve with peaks and troughs, but the wave is actually made up of several simple sine curves representing constituent frequencies, as described by Jean B. J. Fourier.

The string theory of interacting strings and superstrings, the latest explanation of relativistic quantum fields, which includes gravity in a “Theory of Everything,” unifies electroweak, strong nuclear, and gravity forces. In the string theory, the elementary particles we observe in particle accelerators can be thought of as the “musical notes” or excitation modes of elementary strings. In string theory, as in violin playing, the string must be under tension in order to become excited. The excitation depends on the tension of the string and how it is bowed or plucked. It is further believed there are boson particles, many of which can occupy the same state at the same time, to transmit force, and fermion particles with accompanying Pauli repulsions, which make up matter states, a kind of supersymmetry. The Planckian-sized particles which transmit force have energy states and masses of 80-90 GeV each, which they can yield up under proper stimulation. These principles of harmonics, complex waves, frequencies, and energy states apply to this amplifier or generator.

A simple sine wave does not produce as much energy without the presence of the modulated wave acting upon circuit components. Since a good, modulated voice signal is non-periodic, it uses all possible frequencies within its bandwidth, hence the modulated AM radio signal. Apparently, a non-periodic component is necessary to capture a fuller spectrum of the varying electromagnetic energies emitted by naturally-occurring or artificially-induced, excited and disassociating nuclear particles.

Natural radioactive substances, such as radium, thorium, uranium, and their mineral combinations, as well as other radioactive substances, emit fast moving beta and alpha particles, neutrons, gamma-ray photons, and other particles, which, when undulated or varied by an external electromagnetic wave passing through them or otherwise influencing them, has the effect of accelerating and decelerating circulating currents or bursts of electrons, causing them to give off waves of certain frequencies as their quantum states change, which can amplify or weaken external electromagnetic waves in the process, depending on whether the quantum energies are added to the external waves in phase or not.

When more than one radioactive element is mixed together within, or otherwise influencing a crystal, semi-conductor, gas, liquid, or metal, the different frequencies of electromagnetic radiation emitted by each element causes a heterodyne phenomenon to take place, wherein at least two beat frequencies are produced, one the difference and one the sum of the originals, together with harmonics. In addition, induced radioactivity in the host material is pronounced, which, in itself, causes the emission of electromagnetic waves from the host material as a mechanical phenomenon. Because of entropy predicted by the Second Law of Thermodynamics, the tendency of matter is to favor the less energetic, lower frequency. The difference in frequency between element A and B is sustained by extra emissions from the higher to conserve the lower.

### DETAILED DESCRIPTION OF THE METHODS OF TIE INVENTION

The Antenna Setup

If an antenna with an Earth ground plane, in conjunction with the current amplifier or generator depicted at 10 in the structured drawings, is used with the herein described methods and apparatus for nuclear energy extraction, some of the energy absorbed by the generator will come from the naturally ionized air around the antenna. The antenna itself, if utilized, may be of almost any configuration. However, the antenna used most successfully to date was a self-resonant double-dipole (called a crossed-dipole by some) or symetrical quadrapole, an upside down L-design with proportional vertical and horizontal polarizing components (about 1 to 2), in conjunction with four, well-grounded counterpoise segments in a guided wave configuration. It was aligned with one of its four 25-foot (7.62 meters) legs pointing to magnetic north, one pointing directly south, one pointing west at right angles to the previous two, and the last pointing east, also at right angles to the north-south pair, all four legs forming a nearly perfect, fifty-foot (15.24 m) cross (1-4 in The Drawings).

The four, horizontal, 25-foot (7.62 m) antenna segments ran parallel to the ground, and were about 12 feet (3.66 m) off the ground. A center wooden pole supported all four segments at one end, while four other wooden poles supported the other four ends of the segments placed in the directions of the compass. Each overhead segment of the antenna was made up of three pairs (6 wires) of alike-twisted (to minimize capacitance), insulated, stranded about 24-gauge copper wires, each encased strand manufactured with about 22 tiny wires inside its plastic insulation cover, all lending the four overhead, ground-parallel segments a desirable, combined copper mass for gathering AM radio signals.

The four horizontal segments were held up by lengths of insulating nylon cord at either end, threaded through steel eye-bolts anchored in the wooden posts near their tops. Every comparable segment, angle, or part of the four-segment antenna and its counterpoises was, as near as possible, the same length to augment harmonic self-resonance and sympathetic electrical oscillations.

Each horizontal segment had a vertical lead-down wire descending at the center pole, made up of two plastic-insulated, copper wires, also twisted around each other to minimize capacitance between the two strands. The double antenna lead-down wires were attached by careful silver soldering to the center-pointing end of each overhead, ground-parallel antenna segment, and were well-taped over with black electrician's tape. The four lead-down wire pairs, one twisted pair from each of the four segments (eight individual wires total), were bound together lightly with the others at ground level to form a loose cable starting at the base of the center pole, and ran along the surface of the ground for about 65 feet (19.81 m) into the house through the nearest window to where the amplifier or generator was resting on a table. Before the antenna was connected to the amplifier or electric generator in the house, the end of each lead-in wire was bared and all were twisted together to form one large lead.

Back outside where the antenna was located, under each of the four 25-foot (7.62 m) segments of the overhead antenna, running parallel to and about four inches (10.16 cm) off the ground, was a twisted, double-stranded counterpoise wire of a length equal to each antenna segment (5-8 in The Drawings). Each counterpoise segment was attached to the five poles in the same manner as the overhead antenna segments, and their twisted, twin lead wires also formed a loose surface ground cable which went into the house through the same window, and were connected in the same manner as the antenna wires.

Also, an eight-foot (2.44 m), copper-clad, steel rod was driven into the ground near each counterpoise segment, and one end of a short, insulated copper wire was silver soldered to the steel rod end protruding out of the ground, and the other end of the wire was soldered to the counterpoise next to the steel rod at one-quarter length of the counterpoise segment, measured from the center pole end of the counterpoise.

The antenna and grounded counterpoise setup was erected over a residential septic drain field, so the soil was wet down deep and was very conductive, forming a good electrical ground for the four steel rods driven into the Earth.

While the antenna and grounding components described above were not radioactively influenced, the antenna would have been even more sensitive to input signal voltages had that been the case.

The Special Diodes or Valves

The special, amplifying diodes or valves (18, 19, 26, 27, 38, 39 in The Drawings) were crystalized PbS (galena), good for low frequency radio wave reception because of their relatively high, natural, internal resistance, although other semiconductor materials (even gas and vacuum tubes or their equivalents) and other methods will work, too. After doping or alloying with radioactive materials, the crystalized PbS chunks were probed for polarity, or for n (negative) and p (positive) junctions using a cat-whisker assembly, then medium-sized pieces of the crystal were embedded in “woodsmetal,” a very low melting point alloy of tin, bismuth, lead or similar combination of metal conductors.

The galena was first melted in a test tube and doped or alloyed with UO, ten to twenty parts galena to one part radioactive material, then the test tube broken to recover the plug after it cooled. The doped PbS had to be crystalized to function as a diode, meaning it could not have so high a content of radioactive material in it that it would not form a PbS crystal when it cooled.

Several different radioactive materials worked in these diodes. Depleted UO worked well. Nuclear elements recovered from raw uranium ore worked well, yielding a combination of several radioactive isotopes and elements. (Radium would be an ideal dopant, as would “nuclear waste,” substantially uranium and plutonium isotopes. Unstable fission progeny will work well, too.) Typically, only a total of about ten grams or less was needed in all of its parts combined together to obtain the high power output, including in the semi-conductor valves, conductors, capacitors, and transformers.

The diodes used herein were positive and negative types. In each stage of the device employing an external antenna with an earth ground plane—in the parts of the circuit where the diodes were used—one of both types was inserted. (But only one diode was necessary in some configurations.) One diode was polarized to pass one-half the wave, and the second diode passed the other one-half This prevented flyback, and cancelled inductive reactance.

The diode method of detection used in this rectifying, oscillating, and amplifying generator circuit has the advantage over other methods of demodulating a radio frequency carrier wave in that it produces less distortion, and its dynamic characteristic can be made more linear than that of other detectors, but other methods and means will work, too. Normally, a diode does not amplify the incoming signal, and it tends to draw current from the input circuit to reduce selectivity of the input circuit, but these radioactively transformed diodes added power to the circuit, while still drawing current from the input circuit for a substantial overall power gain.

The Special Staged Transformer Core and Coils

The generator may have as many stages of amplifying transformers (one of several means of amplification) as desired, but the configuration used herein had four stages, three of which, excluding the first detector stage, were mounted on a single, soft steel core about ½-inch (1.27 cm) in diameter and about 18 inches (45.72 cm) long (L2-7 in The Drawings). Each stage added quantum energies to the last. The aforementioned transformer core was a bundle of straight wires, each wire coated with shellac, and all bound together with black, plastic, electrical tape. The transformer core wires needed to be made mildly radioactive, about as much so as low-grade uranium ore, by whatever means available to make them so. (Simply including granulated, radioactive material among bare wire strands of the core should work.) The transformer core described herein was fabricated out of slightly radioactive, soft steel wire made in (Red) China, and sold in U.S. stores as “picture frame wire.” That wire was about 18 gauge, was square-shaped, black, and unplated, but other shapes of the same kind of wire will work as well. It should be noted that radioactive elements, such as samarium and neodymium incorporated into strong permanent magnets lose all radioactivity as their disassociating atomic energies are converted into magnetic flux.

The small, about one-inch-diameter (2.54 cm), pancake-shaped, flat transformer coils were wound one wire thick (with about 22-24 gauge copper transformer wire) per course or layer on a hollow paper tube which fitted over the iron-wire-bundle transformer core. Six pancake coils in all, each wound on a short paper tube section, two coils per stage (a primary and a secondary winding), were slid like donuts over the steel-wire transformer core. As stepup or stepdown ratios in the coils were needed, the number of layers in each individual coil reflected those ratios which were always in multiples of each other to take advantage of harmonic-like phenomena.

The initial stage circuit terminating in what normally would have been the crystal radio headphone load was wound one to two, primary to secondary. The next stage was a stepup ratio of one to ten, primary to secondary, and the following stage was a stepdown ratio of twenty to one, the circuit terminating in a full-wave rectifier and resistance load. The rectifier converted the alternating current to direct current (DC) for purposes of error-free measurement and ease of use, and was not necessary to make the generator work, nor was the large resistor.

Every coil of this transformer series was of the same diameter, only thicker or thinner, having more or fewer courses, depending on turn ratios desired. The ratios or layers of the coils were in multiples of each other, representing harmonic relationships between different lengths of electric wires. Each course or layer of wire in the pancake coils was coated with shellac, after being wound, to make it rigid, and to make the wire adhere to itself without damaging the factory applied transformer wire insulation. As with conventional transformers, paper was also used between layers to provide rigidity and to increase insulation to prevent cross-arcing among layers. These flat coils coupled more efficiently with each other than usual helix-type inductances, but the latter will also work.

The reason there were stepup and stepdown transformers employed herein (although transformers and other components may suppress harmonics) was to take advantage of varying harmonic-like voltages, currents, and frequency relationships which yielded more power than otherwise obtainable from a steady, fundamental voltage and frequency. For instance, radio engineers working with vacuum tubes know to compensate for a frequency double the incoming line frequency, because it can draw heat out of vacuum tube cathodes, as does half the base frequency. This well-known phenomenon is related to the number of nodes produced in alternating currents. In other words, the harmonics exploited in the generator described herein, which is itself a large transducer made up of smaller transducers, can absorb heat and quantum energies, and deliver them in usable amounts elsewhere in a circuit, such as to the load.

Amplifying transformer inductances situated on the common, open iron core developed much, if not most, of their power using the demodulated, non-periodic, audio-frequency range part of the radio signal, although other frequency ranges also work. The open core configuration was selected, in this specific application, to reduce heat generation and electric arcing at the high frequencies utilized, but other core configurations will work, too.

The first transformer stage (L1 in The Drawings) was the low bypass filter contained in the much-altered crystal radio. In its unaltered form, it was obtainable at a hobby store, or built from magazine or book schematics, a device popular in the early 1900s, and viewed more as a scientific curiosity today. The one used herein had a sintered-ferrous or an air-core low bypass filter. This greatly-modified radio received the trigger input signal in one embodiment of this amplifier or generator.

Off-the-shelf crystal radios typically utilize a standard, one-diode detector or “valve” to demodulate only one-half the incoming wave; however, the one used in the generator described herein was significantly altered with the insertion of two galena (PbS) diodes doped with radioactive elements, one a positive diode and the other a negative diode, or diodes which each allowed one-half the incoming, modulated AM radio wave to pass, amplifying it in the process. Also, an air capacitor, similar to that described as follows, was inserted in the crystal radio stage in series with a special, radioactively-transformed, fixed capacitor, also described hereafter.

The Standard, as Well as Special Capacitors

There were two types of capacitors employed in each stage of the device utilizing the external antenna and Earth ground plane. The first type was a standard, adjustable, four-gang air capacitor. It had two 560 mfd gangs, one 300 mfd, and one 150 mfd gang on a single shaft, plus a couple of attached, independent, adjustable mica trimmer capacitors. Not all these adjustable capacitors were needed for tuning, and just about any variety of air-core or adjustable capacitor will work in the circuit, provided it gives adequate capacitance. The first, the crystal radio detector circuit, was further altered when it was fitted with one of these adjustable, four-gang capacitors (C1 in The Drawings). Subsequent stages used one of these or one or more separate, adjustable mica trimmer capacitors (C2-6 in The Drawings) to tune each coil, always in series with a fixed, radioactively transformed capacitor explained as follows.

The second type was a specially-fabricated, fixed capacitor, about 3 inches (7.62 cm) in diameter (C7-12 in The Drawings). Each of these capacitors was a pair of discs of conducting metal—such as brass or copper—with a copper lead wire soldered to each disc. Any of several, electrically-conducting materials and shapes may be used for the capacitor plates—nickel, platinum, carbon, copper, bismuth, silver, gold, zinc, thorium, etc., or any combination of these conductors. Between each pair of discs of these fixed capacitors was inserted a slightly larger disc of coffee filter paper, each side of which was lightly dusted with finely powdered UO or some other radioactive element or combination of elements to produce a thin film. The in-turned disc surfaces were first scratched with fine sandpaper or steel wool, and washed with alcohol. (To do away with the thin film of powdered UO, an acid solution containing the same element or combination of radioisotopes may be used to etch the in-turned surfaces, or the discs may be actually alloyed with, composed of, or otherwise brought into contact with radioactive elements by whatever means available to do it. A multitude of radioactive substances will work herein, the same kinds mentioned in conjunction with the special diodes and special transformers, such as “nuclear waste,” fission progeny, radium, tritium, and so on.) After the capacitor plates were assembled congruently face to face, they were squeezed together in a vise to limit the presence of air, while hot plastic glue or wax was applied around the circumference to hold the pieces together as one unit.

These disc capacitors amplified electric power in the circuit in which they were placed when the many, “random,” disassociating nuclear particles struck the plate faces to produce ions and free electrons, or when the atomic particles and rays imparted their kinetic energies to periodic and non-periodic, in-phase electric and magnetic fields, sometimes called Maxwellian “displacement currents” which were induced in and around the capacitor plates.

Pre-tuning and Connecting the Generator to the Antenna and Ground Wires

Before connecting the much-altered radio first stage with its subsequent amplifying stages to the antenna and ground wires, the completely assembled generator was subjected to pre-tuning to a selected radio frequency, utilizing a signal generator in conjunction with an oscilloscope. Each stage was tuned for maximum power output, observing the null points appearing on the oscilloscope, meaning both the primary winding and secondary winding of each tight coupled stage were brought into resonance or into exact phase with the other stages to produce a coherent wave overall. (Lasers may be substituted in similar applications.) Coupling was further assured by the common flux lines present in the iron core-wires of the transformer. As each additional stage was added, the preceding windings were re-tuned, along with the new one, until every coil of every stage was tuned exactly, or brought into exact resonance with the incoming signal.

This tuning was done by sliding the transformer pancake coils back and forth on the slender, wire-bundle transformer core, and by rotating the air capacitors and mica trimmer capacitors as needed. One reason each pancake coil required tuning to resonance with the others is because it is known a signal fed through a transformer becomes slightly de-tuned or out of phase in the secondary winding. In one sense, all the subsequent windings were tuned secondaries of the very first one.

This tuning procedure was lengthy when cat whisker diodes were used in every stage. Only the radio stage, the first one, once set, remained unchanged during pre-installation tuning.

After all the transformer coils were optimally positioned, they were hot-glued in place, and the generator was connected to the external antenna and ground wires, with a 100 megaohm, wire-wound resistor across the output leads. (The resistor was a safety measure to prevent uncontrolled power dissipation and melting heat.) The power buildup time was about a minute to produce about 4,700 watts DC, measured with a pre-installed electric meter. It was advisable to switch or change loads slowly.

Post Operational Observations

Careful, tuning for near-perfect resonance was desirable. When the generator was properly tuned, reflected impedance was minimized, and wave coherence was maximized. Circuit design kept the transformer core from becoming saturated with other out-of-phase and inhibiting frequencies. At resonance, inductive reactance was at a maximum and capacitive reactance was at a minimum, these two canceling each other out, leaving only the resistance inherent in the circuit, which was obviously negligible. Any circuit resistance was offset or nullified by the presence of nuclear particle quantum energies amplifying the man-made electromagnetic waves activating the circuit, which yielded a great amount of non-linear, so-called “free energy.”

Certainly, the energy present in the amplifier or generator when the current in the circuit oscillated back and forth, or was released in heat and electromagnetic wave radiation could not be equal only to that stored in the rising and falling magnetic fields in the inductances, nor in electric fields present in the capacitances. The energy manifesting itself as heat and electromagnetic energy in the generator came from a much larger reservoir, the enormous energies released by spontaneous or induced atomic dissociations. The small generator produced electric power from none other than safe, controlled, atomic energy.

When the amplifier or generator was running, sometimes the exterior antenna produced a tall, swirling, vortex column of light. Immediately in the vicinity of the antenna, visible to the eye and detectable with electromagnetic wave sensing equipment, the light was brilliant, illuminating the whole area. The light was caused by ionized air which blackened grass growing near the counterpoise wires, but did not harm the wires nor their insulating plastic sheaths. Even on still days and nights when the amplifier was not connected to it, the antenna sometimes produced a tall column of pale blue light, the diameter of the antenna, rising to the zenith for miles (kilometers).

The antenna and ground wires of the generator formed part of the secondary inductance of a tank circuit, the antenna and Earth's ground plane substituting as the two capacitor plates, with the air between being the dielectric. During operation, the L-C circuit so formed rang as undamped charges oscillated back and forth between the capacitor and the inductance, amplified and powered by the energies emitted in the circuit components. The carefully tuned primary circuit components acted as a single resonant tank circuit.

This amplifier or generator is in several ways very dissimilar to a Tesla coil, Oudin oscillator, a Rhumkorff coil, or a Henry transformer.

When either the antenna wire or the ground wire was disconnected while the generator was running, a spark about 4 to 8 inches (10.5 to 21 cm) long jumped across the gap, depending on daily atmospheric conditions.

When the prototype generator was operating at its maximum output, the current in its circuits acquired a momentum of its own, and the isotropic circuit values caused it to find its own resonant frequency. The power output of the machine also adjusted itself to carry almost any load placed on it, large or small.

As an electromagnetic wave transmitter-receiver, the generator was able through its antenna to draw off charges in ionized gases produced by other means, conducting a portion of storm induced ionizations in the air (nitrogen and oxygen gases) through its circuits. The generator's antenna and grounding components also interacted with the Earth's magnetic field.

When the generator was running, a magnetic compass held next to the antenna and ground lead-in wires appeared unaffected, most likely because of either too low a current oscillating in the wires, or because the magnetic field reversed too rapidly for the compass needle to follow it.

Absorption of Nuclear Energy by Other Amplifying Valves

Another example of a crystaline semi-conductor absorbing energy from radioactive elements, and re-emitting that absorbed energy as additional electric power was discovered by experimentation relative to the amplifier or generator described herein (FIG. 2 in The Drawings). Paint from the power transistor of a conventional hi-fi speaker amplifier was scraped off to reveal the bare silicon crystal material underneath. Placed upon the bare silicon was granulated UO. The increased power drawn into the transistor from the nuclear material melted the windings in the down-circuit speaker, destroying it completely. This demonstrated how a non-periodic, audio-frequency wave (or a similar wave associated with other frequency ranges and bandwidths) activates and absorbs the quantum energies emitted by radioactive elements in conjunction with crystaline semi-conductors and metal conductors. This experiment revealed the key to making this generator mobile for propelling land vehicles, ships, and aircraft without the use of an external antenna and Earth ground plane. Designing suitable oscillatory circuits is all that is necessary, utilizing simple electronic devices to provide trigger signals.

Conclusion, Ramifications, and Scope of the Invention

Thus, the reader will see this solid-state or near solid-state amplifier or generator can be utilized by anyone anywhere who normally uses electric power. The generator frees the user from being connected to and from being reliant on public utility power grids, and from being reliant on fossil and other chemical fuel sources. The fuel it utilizes is inexpensive, lasts months to years, and very little fuel is needed in comparison with fossil fuels which are the most common energy source at this time. The generator is compact for the amount of electric energy it produces, weighing but a few pounds, unlike other bulky methods, such as Sun, wind, hydroelectric, geothermal, chemical and nuclear batteries, fossil fuel transducers, and conventional nuclear power plants.

While the above description contains many specifications, these should not be construed as limitations on the scope of the invention, but rather as an exemplification of a preferred embodiment thereof. Many other variations are possible. For example, this current enhancer, amplifier, transducer, or electric generator can be built small enough to power a watch, or large enough to power ships at sea, cities on land, or settlements in space. It can power land vehicles, aircraft, watercraft, homes, businesses, and farms.

The generator may be constructed in many sizes, colors, or shapes. The parts in other configurations and refinements may be multiplied to derive more power, or minimized to derive less power. Parts, such as the antenna, grounding parts, cat whisker diodes, capacitors, and transformers can be eliminated, combined with other components, or altered in several ways. The tuning parts may be eliminated or substituted for vacators, frequency synthesizers, or similar components. The tuning procedure itself may be completely eliminated, changed, or automated. The circuit and circuit components may be altered, changed in shape, function, and size, substituted for others, made less complicated, and accompanied by local control, timing, noise-suppressing, signal, and switching circuits. It may have light or heavy shielding. The parts may be made as plug-in modules and printed circuits; and made in conjunction with lasers, gas plasmas, magnets, crystals, a variety of semi-conductors and other amplifying valves, whether solid-state components or vacuum and gas-filled tubes or their equivalents; made with combinations of conductor metals, a variety of natural and manmade fuel isotopes and sources, not excluding tritium, deuterium, and protium; made with focusing apparatuses; and made in a multitude of other ways which apply the methods and apparatus described herein.

Small iron or nickel-platinum tubes filled with deuterium, deuterium oxide, and tritium, especially in conjunction with other solid radioisotopes may be substituted in oscillatory circuit components, such as in the capacitors and transformers. The whole amplifier or parts of it may be immersed in hydrogen isotopes.

Accordingly, the scope of the invention should be determined not by the embodiments illustrated, but by the appended claims and their legal equivalents.

Any improvements to the generator, its control, and its applications are obvious to electronic engineers and physicists, once they are shown the principles of the generator's operation.

Additional objects and features of the invention will become apparent from the following detailed description and drawings.

### THE DRAWINGS

In the drawings:

FIG. 1 is an electric circuit schematic of an electric current enhancer, amplifier, or generator utilizing an antenna and Earth ground plane;

FIG. 2 is an electric circuit schematic of a radioactively transformed power transistor without an antenna and Earth ground plane.

### DETAILED DESCRIPTION OF APPARATUS OF THE INVENTION

Referring now to the drawings:

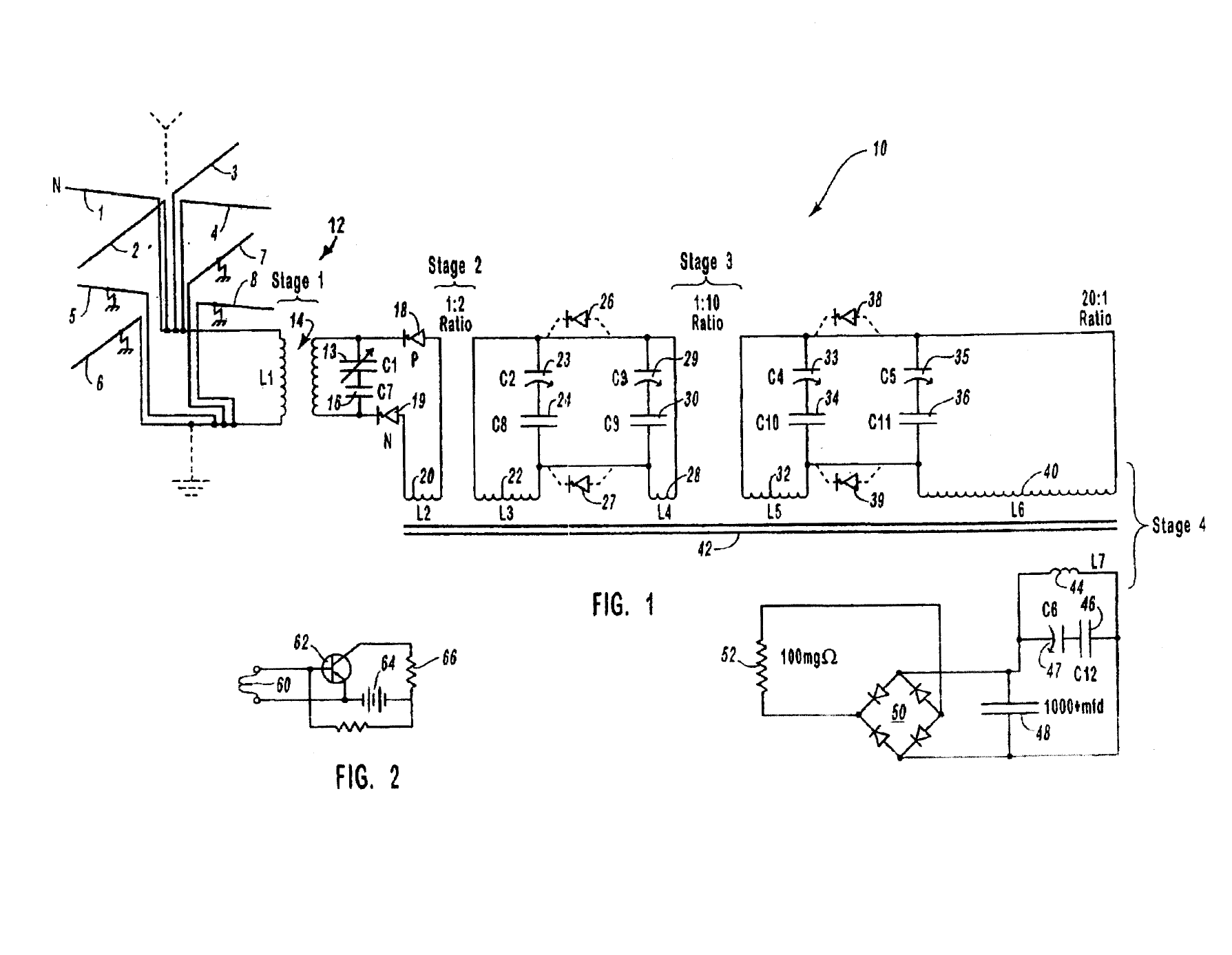

An illustrated preferred embodiment of a device utilizing an antenna with an Earth ground plane in FIG. 1 is shown generally at 10. The overhead antenna segments 1, 2, 3, 4 are matched by counterpoise segments and grounding rods 5, 6, 7, 8. The antenna and Earth ground plane first stage 12 is a greatly altered AM radio receiver having an air-core or sintered, ferromagnetic primary and secondary (also called a low bypass filter) 14. Filter 14 connects in parallel to an adjustable ganged air capacitor 13 and a fixed or set, radioactively-transformed capacitor series 16 which is further connected, i.e. through two radioactively doped cat whisker diodes 18 and 19 to the primary 20 of a stage two, the earphone or load of the radio circuit.

The primary 20 of stage two steps up the voltage one to two in the secondary winding 22 of stage two. Again, 22 connects in parallel-series to an adjustable air-capacitor or mica trimmer capacitor 23 and a fixed, radioactively-influenced capacitor 24 which connect in parallel optionally through two more doped cat whisker diodes 26 and 27 to the primary 28 of stage three, passing in parallel through another series of an adjustable air-capacitor or an adjustable mica trimmer 29 and a fixed, radioactively-transformed capacitor 30. The reason every coil in each stage is tuned separately is because as a signal passes through a transformer, it exits slightly de-tuned from the secondary winding.

The stepup ratio of the primary 28 to the secondary 32 transformer winding of stage three is one to ten, and has exactly the same components as the previous stage two. The adjustable series-parallel trimmer or air-capacitors 33 and 35 and fixed radioactively-influenced capacitor series 34 and 36, may go through optional diodes 38 and 39, and terminate in transformer winding 40. All transformer windings except 14 tight-couple together through transformer iron core 42.

Primary transformer winding 40 steps down the voltage twenty to one to secondary winding 44, again connected to a parallel-series capacitor array 46, a fixed one, and an adjustable one 47, exactly like foregoing stages. Capacitor 48 is a standard, alternating current capacitor of about one thousand microfarads to smooth out ripples in the current, and is connected as shown to a standard, full-wave rectifier 50, which is connected directly to the two leads of the load 52, in this case shown as a one hundred megaohm resistor which may be switched in and out of the circuit to accommodate other loads or purposes for which the circuit may be used.

FIG. 2 shows an incoming trigger signal from a source 60 other than an AM radio station, leading to a radioactively-influenced transistor 62, which connects to a conventional battery power source 64 and useful load 66 such as a light bulb resistance.

Although preferred embodiments of the invention have been described herein it is to be clearly understood that the present disclosure is by way of example only and that variations are entirely possible without departing from the subject matter coming within the scope of the following claims, which subject matter is regarded as the invention.

We claim:

1. A method of converting nuclear energy to useable electric power which comprises the steps of
(a) applying radioactive elements to transducers structured as radioactively transformed circuit components;
(b) applying oscillating waves and voltages to said transducers; and
(c) collecting electrical energy generated by said transducers.

2. The method of claim 1, wherein
the transducers are semi-conductor valves.

3. The method of claim 1, wherein
the transducers are capacitors.

4. The method of claim 1, wherein
the transducers are transformers.

5. The method of claim 1, wherein
the transducers are selected from the group comprising diodes, controllable semi-conductor valves, conductors, capacitors, inductors, transformers, rectifiers, oscillators, and amplifiers.

6. The method of claim 1 further comprising
using an antenna with an Earth ground plane receiving radio waves as a source of oscillating voltages applied to radioactively transformed circuit components.

7. The method of claim 6, wherein
the antenna and Earth ground plane form part of a secondary inductance of a tank circuit with the antenna and Earth's ground plane acting as the two capacitor plates of the tank circuit with the air between said antenna and said Earth's ground plane being the dielectric of said tank circuit.

8. The method of claim 1 further comprising
utilizing from whatever means available, in the absence of an external antenna and Earth ground plane, oscillating waves and voltages to stimulate radioactively transformed circuit components.
